(19) United States
(12) Patent Application Publication
(10) Pub. No.: US 2025/0092730 A1
(43) Pub. Date: Mar. 20, 2025

(54) VEHICLE DOOR OPENING AND CLOSING DEVICE AND VEHICLE

(71) Applicants: Zhejiang ZEEKR Intelligent Technology Co., Ltd., Ningbo (CN); Zhejiang Geely Holding Group Co., Ltd., Hangzhou (CN)

(72) Inventors: Wen LU, Ningbo (CN); Da HE, Ningbo (CN); Xianjing FENG, Ningbo (CN); Te YIN, Ningbo (CN); Xiaoyuan JIANG, Ningbo (CN); Dacheng YANG, Ningbo (CN)

(73) Assignees: Zhejiang ZEEKR Intelligent Technology Co., Ltd., Ningbo (CN); Zhejiang Geely Holding Group Co., Ltd., Hangzhou (CN)

(21) Appl. No.: 18/966,930

(22) Filed: Dec. 3, 2024

Related U.S. Application Data
(63) Continuation of application No. PCT/CN2023/097932, filed on Jun. 2, 2023.

(30) Foreign Application Priority Data
Jun. 7, 2022 (CN) 202210639343.7

(51) Int. Cl. E05F 15/63

(52) U.S. Cl. CPC E05F 15/63; E05F 2015/631; E05Y 2201/434; E05Y 2201/686; E05Y 2900/531

(57) ABSTRACT

Disclosed in the present disclosure is a vehicle door opening and closing device, including an active arm, a guide rail seat, and a driven mechanism. The active arm vehicle body end of the active arm is rotatably connected to the vehicle body, and the active arm vehicle door end of the active arm is rotatably connected to the vehicle door. The guide rail seat is fixed on the vehicle door, and the guide rail seat is provided with a guide rail that matches the preset opening and closing trajectory of the vehicle door. One end of the driven mechanism is rotatably connected to the guide rail seat, and another end of the driven mechanism is rotatably connected to the vehicle body. The driven mechanism is provided with a first sliding part slidably connected to the guide rail.

### CROSS REFERENCE TO RELATED APPLICATIONS

This application is a continuation application of International Application No. PCT/CN2023/097932, filed on Jun. 2, 2023, which claims the benefit of priority to Chinese Application No. 202210639343.7, filed on Jun. 7, 2022, both of which are incorporated herein by reference in their entireties.

### TECHNICAL FIELD

The present disclosure relates to the field of automotive technology, and in particular to a vehicle door opening and closing device and a vehicle.

### BACKGROUND

With the development of the automotive industry, people's requirements for vehicle comfort are becoming increasingly high. The size of the interior space after opening the vehicle door, the convenience of carrying large items onto and off the vehicle, and the convenience of opening and closing the vehicle door are important indicators for users to measure vehicle comfort. Therefore, B-pillar free vehicle models have emerged. At present, there are more and more vehicle models without B-pillars, and the doors of these vehicle models are becoming more diverse, such as swing doors and opposite doors.

### SUMMARY

In the present disclosure, a vehicle door opening and closing device and a vehicle are provided. The vehicle door opening and closing device is provided with a guide rail that matches a predefined opening and closing trajectory of the vehicle door on a guide rail seat, and a first sliding part that slides along the guide rail on a driven mechanism, such that the vehicle door can be opened and closed separately along the predefined opening and closing trajectory of the vehicle door under the drive of an active arm, without being limited to another vehicle door, thereby improving the experience of passengers.

In some aspects, the present disclosure provides a vehicle door opening and closing device, including an active arm, a guide rail seat, and a driven mechanism; where an active arm vehicle body end of the active arm is rotatably connected to a vehicle body, and an active arm vehicle door end of the active arm is rotatably connected to a vehicle door; the guide rail seat is fixedly mounted on the vehicle door, and the guide rail seat is provided with a guide rail that matches a predefined opening and closing trajectory of the vehicle door; one end of the driven mechanism is rotatably connected to the guide rail seat, and the other end of the driven mechanism is rotatably connected to the vehicle body; and the driven mechanism is provided with a first sliding part, where the first sliding part is slidably connected to the guide rail.

In some embodiments, the driven mechanism includes a first driven arm and a second driven arm that are rotatably connected; an end of the first driven arm away from the second driven arm is rotatably connected to the vehicle body, and an end of the second driven arm away from the first driven arm is rotatably connected to the guide rail seat; and the first sliding part is provided on the first driven arm.

In some embodiments, a second sliding part is provided at an end of the first driven arm close to the second driven arm, and a position limiting groove that matches with the second sliding part is provided at an end of the second driven arm close to the first driven arm; where the second sliding part is rotatably connected to the position limiting groove, and a size of the position limiting groove in a length direction is greater than an outer diameter of the second sliding part.

In some embodiments, the first sliding part is provided between the end of the first driven arm away from the second driven arm and the second sliding part.

In some embodiments, the first sliding part includes a first sliding shaft and a first position limiting end that are fixedly connected. The first sliding shaft is fixedly connected to the first driven arm, and the first position limiting end has a larger diameter than the first sliding shaft.

In some embodiments, the second sliding part includes a second sliding shaft and a second position limiting end that are fixedly connected. The second sliding shaft is fixedly connected to the first driven arm, and the second position limiting end has a larger diameter than the second sliding shaft.

In some embodiments, the vehicle door opening and closing device includes at least two of the guide rail seats and at least two of the driven mechanisms, and the at least two of the guide rail seats are provided, respectively corresponding to the at least two of the driven mechanisms.

In some embodiments, the vehicle door opening and closing device further includes a driving mechanism, where the driving mechanism is electrically connected to vehicle controller; and the driving mechanism is in transmission connection with the active arm.

In some embodiments, the guide rail is S-shaped, and the position limiting groove is strip-shaped.

In some aspects, the present disclosure provides a vehicle including the vehicle door opening and closing device as described in any one of the above embodiments.

### BRIEF DESCRIPTION OF DRAWINGS

In order to provide a clearer explanation of the technical solutions in the embodiments of the present disclosure, a brief introduction will be given to the accompanying drawings required for the description of the embodiments. The drawings in the following description only relate to some embodiments of the present disclosure. For those skilled in the art, other drawings can also be obtained according to these drawings without creative effort.

FIG. 1 is a schematic structural diagram of a first state of a vehicle door opening and closing device provided in embodiments of the present disclosure.

FIG. 2 is a schematic structural diagram of a second state of a vehicle door opening and closing device provided in embodiments of the present disclosure.

FIG. 3 is a schematic structural diagram of a first angle of a vehicle door opening and closing device provided in embodiments of the present disclosure.

The following is a supplementary explanation for the accompanying drawings: 10—active arm; 11—active arm vehicle body end; 12—active arm vehicle door end; 20—guide rail seat; 21—guide rail; 30—driven mechanism; 31—first driven arm; 32—second driven arm; 321—limiting groove.

### DETAILED DESCRIPTION

In order to enable those skilled in the art to better understand the solution of the present disclosure, a clear and complete description of the technical solution in the embodiments of the present disclosure will be provided below in conjunction with the accompanying drawings. The described embodiments are only a part of the embodiments of the present disclosure, and not all of the embodiments. Other embodiments achieved by those skilled in the art according to the embodiments in the present disclosure without paying creative work shall all fall within the scope of protection of the present disclosure.

The term “an embodiment” or “embodiments” herein refers to a feature, a structure, or a characteristic that may be included in at least one embodiment of the present disclosure. In the description of the present disclosure, it should be understood that the terms “up,” “down,” “top,” and “bottom” etc. indicate orientation or positional relationships based on the orientation or positional relationships shown in the accompanying drawings, which is only for the convenience of describing the present disclosure and simplifying the description, instead of indicating or implying that the device or component referred to must have a specific orientation, be constructed and operated in a specific orientation, and therefore cannot be understood as a limitation of the present disclosure. In addition, the terms “first” and “second” are only for descriptive purposes, and cannot be understood as indicating or implying relative importance or the quantity of the technical feature indicated. Therefore, features limited by “first” and “second” can explicitly or implicitly include one or more of these features. Moreover, the terms “first,” and “second,” etc., are used to distinguish similar objects and are not necessarily used to describe a particular order or sequence. It should be understood that the objects defined by “first” and “second” may be interchangeable in appropriate circumstances, such that the embodiments described herein can be implemented in order other than those illustrated or described herein.

In order to facilitate the explanation of the advantages of the vehicle door opening and closing device in the embodiments of the present disclosure, at the beginning of the description of the technical solution of the embodiments of the present disclosure, the relevant content is first summarized.

In related arts, in the width direction of the vehicle body, there is partial structural overlap between the front swing door and the rear swing door on the same side of a B-pillar free vehicle model, and therefore, the front swing door has a position limiting effect on the rear swing door. The opening of the rear swing door of the B-pillar free vehicle model adopts a four-bar linkage mechanism, which causes the rear swing door to rotate outward when the rear swing door starts swinging. Due to the limit of the front swing door on the rear swing door, it is generally necessary to open the front swing door first before the rear swing door can be opened, and the rear swing door cannot be opened separately, resulting in a poor driving experience for users.

In view of the shortcomings in the related arts, in the present disclosure, the vehicle door opening and closing device is provided with a guide rail that matches a predefined opening and closing trajectory of the vehicle door on a guide rail seat, and a first sliding part that slides along the guide rail on a driven mechanism, such that the vehicle door can be opened and closed separately along the predefined opening and closing trajectory of the vehicle door under the drive of an active arm, without being limited to another vehicle door, thereby improving the experience of passengers.

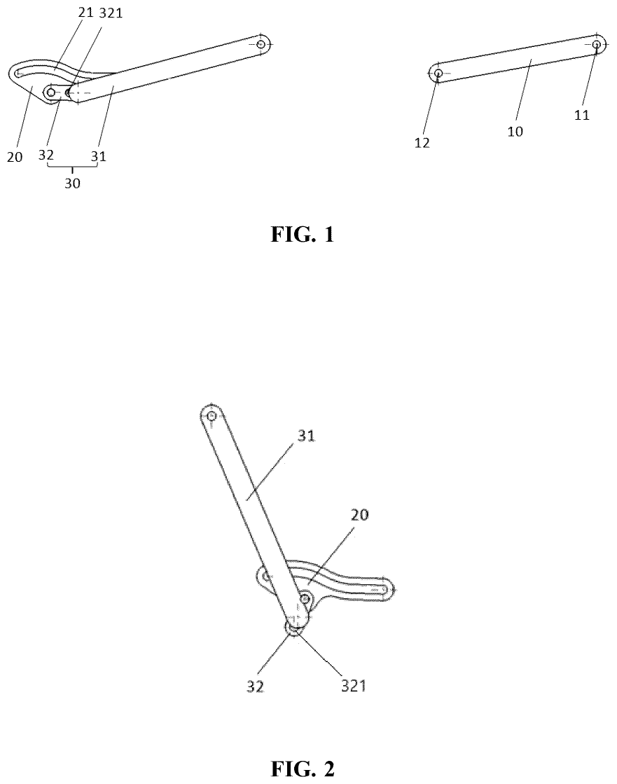

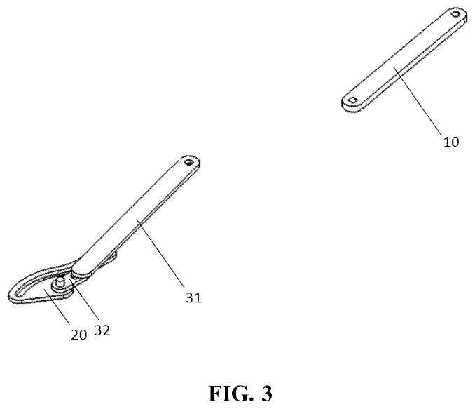

Referring to FIGS. 1 to 3. In the embodiments of the present disclosure, the vehicle door opening and closing device is applied to the opening and closing of the rear vehicle door of a B-pillar free vehicle model. The vehicle door opening and closing device includes an active arm 10, a guide rail seat 20, and a driven mechanism 30. The active arm vehicle body end 11 of the active arm 10 is rotatably connected to the vehicle body, and the active arm vehicle door end 12 of the active arm 10 is rotatably connected to the vehicle door. The guide rail seat 20 is fixed on the vehicle door, and the guide rail seat 20 is provided with a guide rail 21 that matches the predefined opening and closing trajectory of the vehicle door. One end of the driven mechanism 30 is rotatably connected to the guide rail seat 20, and the other end of the driven mechanism 30 is rotatably connected to the vehicle body. The driven mechanism 30 is provided with a first sliding part, where the first sliding part is slidably connected to the guide rail 21.

In an embodiment, the vehicle door is provided with a mounting seat for the guide rail seat, and the guide rail seat 20 is fixedly mounted on the mounting seat for the guide rail seat. For example, the mounting seat for the guide rail seat is provided on a side of the vehicle door facing the interior space of the vehicle.

In an embodiment, the guide rail seat 20 is provided with a guide rail 21, where the guide rail 21 is used to constrain the moving trajectory of the vehicle door.

In an embodiment, the driven mechanism 30 is connected to the guide rail seat 20 and the vehicle body. For example, an end of the driven mechanism 30 close to the vehicle door is rotatably connected to the guide rail seat 20, and an end of the driven mechanism 30 close to the vehicle body is rotatably connected to the vehicle body.

For example, an end of the driven mechanism 30 close to the vehicle door is movably riveted to the guide rail seat 20, and an end of the driven mechanism 30 close to the vehicle body is connected to the vehicle body through a pin (also referred to as a pin roll) for rotation.

In an embodiment, the driven mechanism 30 is protrudingly provided with a first sliding part, where the first sliding part slides in conjunction with the guide rail 21.

In an embodiment, for a B-pillar free vehicle model, when both the front and rear vehicle doors are closed, an end of the front vehicle door close to the rear vehicle door and an end of the rear vehicle door close to the front vehicle door overlap along the width direction of the vehicle body, and the end of the rear vehicle door close to the front vehicle door is located on the inner side of the end of the front vehicle door close to the rear vehicle door, that is, the end of the front vehicle door close to the rear vehicle door is an interference area of the front vehicle door with respect to the opening and closing of the rear vehicle door.

In the embodiments of the present disclosure, the vehicle door opening and closing device is provided with a guide rail that matches a predefined opening and closing trajectory of the vehicle door on a guide rail seat, and a first sliding part that slides along the guide rail on a driven mechanism, such that the vehicle door can be opened and closed separately along the predefined opening and closing trajectory of the vehicle door under the drive of an active arm, without being limited to another vehicle door, thereby improving the experience of passengers.

In the embodiments of the present disclosure, the driven mechanism 30 includes a first driven arm 31 and a second driven arm 32 that are rotatably connected. An end of the first driven arm 31 away from the second driven arm 32 is rotatably connected to the vehicle body, and an end of the second driven arm 32 away from the first driven arm 31 is rotatably connected to the guide rail seat 20. The first sliding part is provided on the first driven arm 31.

In an embodiment, the end of the first driven arm 31 away from the second driven arm 32 is rotatably connected to the vehicle body through a pin, and the end of the second driven arm 32 away from the first driven arm 31 is movably riveted to the guide rail seat 20.

In an embodiment, during the relative movement of the vehicle door to the vehicle body, there is both relative rotation and relative sliding between the first driven arm 31 and the second driven arm 32.

In the embodiments of the present disclosure, a second sliding part is provided at the end of the first driven arm 31 close to the second driven arm 32, and a position limiting groove 321 matching the second sliding part is provided at the end of the second driven arm 32 close to the first driven arm 31. The second sliding part is rotatably connected to the position limiting groove 321, and the size of the position limiting groove 321 in the length direction is greater than the outer diameter of the second sliding part.

In an embodiment, a second sliding part is protruding from the end of the first driven arm 31 close to the second driven arm 32. The second sliding part rotates in the position limiting groove 321 and slides in the position limiting groove 321 to move the vehicle door along the predefined opening and closing trajectory of the vehicle door.

In an embodiment, the size of the position limiting groove 321 in the length direction is greater than the outer diameter of the second sliding part, such that the second sliding part can slide along the length direction of the position limiting groove 321 in the position limiting groove 321.

In the embodiments of the present disclosure, the first sliding part is provided between the end of the first driven arm 31 away from the second driven arm 32 and the second sliding part, to achieve the movement of the vehicle door along the predefined opening and closing trajectory of the vehicle door.

In the embodiments of the present disclosure, the first sliding part includes a first sliding shaft and a first position limiting end that are fixedly connected. The first sliding shaft is fixedly connected to the first driven arm 31, and the first position limiting end has a larger diameter than the first sliding shaft.

In an embodiment, the first sliding part is the first ball-head pin, where the first sliding shaft is a first smooth shaft sliding along the guide rail 21, the first position limiting end is a first spherical end, and the diameter of the first spherical end is greater than the outer diameter of the first smooth shaft, so as to prevent the first ball-head pin from slipping out of the guide rail 21.

For example, the guide rail 21 is a first conical guide rail, and the opening of the guide rail 21 towards the first driven arm 31 is smaller than the opening of the guide rail 21 towards the vehicle door.

For example, the first ball-head pin and the first conical guide rail are slidably snapped together.

In the embodiments of the present disclosure, the second sliding part includes a second sliding shaft and a second position limiting end that are fixedly connected. The second sliding shaft is fixedly connected to the first driven arm 31, and the second position limiting end has a larger diameter than the second sliding shaft.

In an embodiment, the second sliding part is a second ball-head pin roll, where the second sliding shaft is a second smooth shaft that slides along the position limiting groove 321, and the second position limiting end is a second spherical end, the diameter of the second spherical end is greater than the outer diameter of the second smooth shaft, so as to prevent the second ball-head pin from slipping out of the position limiting groove 321.

For example, the position limiting groove 321 is a second conical guide rail, and the opening of the position limiting groove 321 close to the first driven arm 31 is smaller than the opening of the position limiting groove 321 close to the guide rail seat 20.

For example, the second ball-head pin and the second conical guide rail are slidably snapped together.

In the embodiments of the present disclosure, the vehicle door opening and closing device includes at least two guide rail seats 20 and at least two driven mechanisms 30, and the at least two the guide rail seats 20 are provided respectively corresponding to the at least two the driven mechanisms 30.

In an embodiment, a guide rail seat 20, a driven mechanism 30, and an active arm 10 are provided between a lower end side of the vehicle door and the vehicle body, and a guide rail seat 20 and a driven mechanism 30 are provided between an upper end side of the vehicle door and the vehicle body, thereby increasing the stability of the vehicle door opening and closing device connecting the vehicle door and the vehicle body.

In another embodiment, a guide rail seat 20 and a driven mechanism 30 are provided between the lower end side of the vehicle door and the vehicle body, and a guide rail seat 20, a driven mechanism 30, and an active arm 10 are provided between the upper end side of the vehicle door and the vehicle body, thereby increasing the stability of the vehicle door opening and closing device connecting the vehicle door and the vehicle body.

In the embodiments of the present disclosure, the vehicle door opening and closing device further includes a driving mechanism, where the driving mechanism is electrically connected to a vehicle controller, and the driving mechanism is in transmission connection with the active arm 10.

In an embodiment, the control system of the vehicle controls the driving mechanism to operate in response to a vehicle door opening or closing signal, and the driving mechanism drives the active arm 10 to rotate through the transmission mechanism.

In the embodiments of the present disclosure, the guide rail 21 is S-shaped, and the position limiting groove 321 is strip-shaped.

In an embodiment, the position limiting groove 321 is a waist shaped hole groove to allow the vehicle door to move along the predefined opening and closing trajectory of the vehicle door under the drive of the active arm 10.

For example, when the front vehicle door is closed and the rear vehicle door needs to be opened, the control system of the vehicle controls the driving mechanism to operate in response to the vehicle door opening signal. The driving mechanism drives the active arm 10 to rotate through the transmission mechanism. The end of the rear vehicle door that is far away from the front vehicle door moves around the active arm vehicle body end 11 under the driving of the active arm 10, and the first sliding part on the first driven arm 31 slides in the guide rail 21, the second sliding part on the first driven arm 31 rotates in the position limiting groove 321 and slides along the position limiting groove, and the second driven arm 32 rotates around the guide rail seat 20. Through the coordinated movement of the first sliding part, the second sliding part, the second driven arm 32, and the guide rail seat 20, the constraint on the movement of the rear vehicle door by the guide rail 21, the first driven arm 31, and the second driven arm 32 is achieved, such that when the rear vehicle door starts to open, the end of the rear vehicle door close to the front vehicle door first performs translational motion to a place where the end of the rear vehicle door close to the front vehicle door leaves the interference area of the front vehicle door for the opening and closing of the rear vehicle door, and then continues to swing, so as to fully open the rear vehicle door according to the predefined opening and closing trajectory of the vehicle door.

The movement trajectory of the rear vehicle door when the rear vehicle door is closed is consistent with that when the rear vehicle door is opened. For example, when the rear vehicle door needs to be closed, the control system of the vehicle controls the driving mechanism to operate in response to the vehicle door closing signal. The driving mechanism drives the active arm 10 to rotate in an opposite direction through the transmission mechanism, and the rear vehicle door swings under the driving of the active arm 10. The first sliding part on the first driven arm 31 slides in the guide rail 21, the second sliding part on the first driven arm 31 rotates in the position limiting groove 321 and slides along the position limiting groove, and the second driven arm 32 rotates with the guide rail seat 20. Through the coordinated movement of the first sliding part, the second sliding part, the second driven arm 32, and the guide rail seat 20, the constraint on the movement of the rear vehicle door by the guide rail 21, the first driven arm 31, and the second driven arm 32 is achieved, such that before the rear vehicle door closes, the end of the rear vehicle door close to the front vehicle door performs translational motion to avoid the interference area of the front vehicle door on the opening and closing of the rear vehicle door, such that the rear vehicle door can be completely closed according to the predefined opening and closing trajectory of the vehicle door.

In addition, the embodiments of the present disclosure further provide a vehicle including the vehicle door opening and closing device as described above.

In the present disclosure, the vehicle door opening and closing device is provided with a guide rail that matches a predefined opening and closing trajectory of the vehicle door on a guide rail seat, and a first sliding part that slides along the guide rail on a driven mechanism, such that the vehicle door can be opened and closed separately along the predefined opening and closing trajectory of the vehicle door under the drive of an active arm, without being limited to another vehicle door, thereby improving the experience of passengers.

The foregoing disclosure is merely illustrative of some examples of the present disclosure but not intended to limit the present disclosure, and any modifications, equivalent substitutions, adaptations thereof made within the spirit and principles of the disclosure shall be encompassed in the scope of protection of the present disclosure.

What is claimed is:

1. A vehicle door opening and closing device, comprising an active arm, a guide rail seat, and a driven mechanism,
wherein an active arm vehicle body end of the active arm is rotatably connected to a vehicle body, and an active arm vehicle door end of the active arm is rotatably connected to a vehicle door;
the guide rail seat is fixedly mounted on the vehicle door, and the guide rail seat is provided with a guide rail that matches a predefined opening and closing trajectory of the vehicle door;
one end of the driven mechanism is rotatably connected to the guide rail seat, and another end of the driven mechanism is rotatably connected to the vehicle body; and
the driven mechanism is provided with a first sliding part slidably connected to the guide rail.

2. The vehicle door opening and closing device according to claim 1, wherein
the driven mechanism comprises a first driven arm and a second driven arm that are rotatably connected;
an end of the first driven arm away from the second driven arm is rotatably connected to the vehicle body, and an end of the second driven arm away from the first driven arm is rotatably connected to the guide rail seat; and
the first sliding part is provided on the first driven arm.

3. The vehicle door opening and closing device according to claim 2, wherein a second sliding part is provided at an end of the first driven arm close to the second driven arm, and a position limiting groove that matches with the second sliding part is provided at an end of the second driven arm close to the first driven arm.

4. The vehicle door opening and closing device according to claim 3 wherein the second sliding part is rotatably connected to the position limiting groove, and a size of the position limiting groove in a length direction is greater than an outer diameter of the second sliding part.

5. The vehicle door opening and closing device according to claim 3, wherein the first sliding part is provided between the end of the first driven arm away from the second driven arm and the second sliding part.

6. The vehicle door opening and closing device according to claim 2, wherein the first sliding part comprises a first sliding shaft and a first position limiting end that are fixedly connected, the first sliding shaft is fixedly connected to the first driven arm, and the first position limiting end has a larger diameter than the first sliding shaft.

7. The vehicle door opening and closing device according to claim 3, wherein the second sliding part comprises a second sliding shaft and a second position limiting end that are fixedly connected, the second sliding shaft is fixedly connected to the first driven arm, and the second position limiting end has a larger diameter than the second sliding shaft.

8. The vehicle door opening and closing device according to claim 1, further comprising at least two of the guide rail seats and at least two of the driven mechanisms, wherein the at least two of the guide rail seats are provided respectively corresponding to the at least two of the driven mechanisms.

9. The vehicle door opening and closing device according to claim 1, further comprising a driving mechanism electrically connected to a vehicle controller and the driving mechanism is in transmission connection with the active arm.

10. The vehicle door opening and closing device according to claim 3, wherein the guide rail is S-shaped, and the position limiting groove is strip-shaped.

11. A vehicle, comprising a vehicle door opening and closing device, the vehicle door opening and closing device comprising an active arm, a guide rail seat, and a driven mechanism,
wherein an active arm vehicle body end of the active arm is rotatably connected to a vehicle body, and an active arm vehicle door end of the active arm is rotatably connected to a vehicle door;
the guide rail seat is fixedly mounted on the vehicle door, and the guide rail seat is provided with a guide rail that matches a predefined opening and closing trajectory of the vehicle door;
one end of the driven mechanism is rotatably connected to the guide rail seat, and another end of the driven mechanism is rotatably connected to the vehicle body; and
the driven mechanism is provided with a first sliding part slidably connected to the guide rail.

12. The vehicle according to claim 11, wherein
the driven mechanism comprises a first driven arm and a second driven arm that are rotatably connected;
an end of the first driven arm away from the second driven arm is rotatably connected to the vehicle body, and an end of the second driven arm away from the first driven arm is rotatably connected to the guide rail seat; and
the first sliding part is provided on the first driven arm.

13. The vehicle according to claim 12, wherein a second sliding part is provided at an end of the first driven arm close to the second driven arm, and a position limiting groove that matches with the second sliding part is provided at an end of the second driven arm close to the first driven arm.

14. The vehicle according to claim 13, wherein the second sliding part is rotatably connected to the position limiting groove, and a size of the position limiting groove in a length direction is greater than an outer diameter of the second sliding part.

15. The vehicle according to claim 13, wherein the first sliding part is provided between the end of the first driven arm away from the second driven arm and the second sliding part.

16. The vehicle according to claim 12, wherein the first sliding part comprises a first sliding shaft and a first position limiting end that are fixedly connected, the first sliding shaft is fixedly connected to the first driven arm, and the first position limiting end has a larger diameter than the first sliding shaft.

17. The vehicle according to claim 13, wherein the second sliding part comprises a second sliding shaft and a second position limiting end that are fixedly connected, the second sliding shaft is fixedly connected to the first driven arm, and the second position limiting end has a larger diameter than the second sliding shaft.

18. The vehicle according to claim 11, wherein the vehicle door opening and closing device further comprises at least two of the guide rail seats and at least two of the driven mechanisms, and the at least two of the guide rail seats are provided respectively corresponding to the at least two of the driven mechanisms.

19. The vehicle according to claim 11, wherein the vehicle door opening and closing device further comprises a driving mechanism electrically connected to a vehicle controller and in transmission connection with the active arm.

20. The vehicle according to claim 13, wherein the guide rail is S-shaped, and the position limiting groove is strip-shaped.
